(19) United States
(12) Patent Application Publication
(10) Pub. No.: US 2011/0041945 A1
(43) Pub. Date: Feb. 24, 2011

(54) Automotive Exhaust Pipe

(76) Inventors: Takahiro Ohmura, Tokyo (JP); Masatake Onodera, Tokyo (JP); Takahiro Niwa, Tokyo (JP); Toshihiko Kumasaka, Tokyo (JP); Akinao Hiraoka, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/860,331

(22) Filed: Aug. 20, 2010

(30) Foreign Application Priority Data
Aug. 21, 2009 (JP) P.2009-192073
Mar. 31, 2010 (JP) P.2010-081803

(51) Int. Cl. F16L 9/14

(52) U.S. Cl. 138/140

(57) ABSTRACT

The present invention relates to an automotive exhaust pipe including: an exhaust pipe main body; and a metallic cylindrical body being inserted inside the exhaust pipe main body, having openings at an open area ratio of 95% or smaller, and having a thickness of 3 mm or smaller.

### FIELD OF THE INVENTION

The present invention relates to an automotive exhaust pipe and more particularly relates to a technique to increase its thermal insulation performance.

### BACKGROUND OF THE INVENTION

In general, exhaust gases of an automotive engine are sent to a catalytic converter through an exhaust pipe and are then discharged to the atmosphere from an exhaust muffler after air pollutant substances have been removed at the catalytic converter. It is desired that the exhaust gases heated to high temperatures flow into the catalytic converter for heating catalyst materials in the catalytic converter to their activating temperatures within a short period of time. Because of this, the exhaust pipe is insulated to prevent a reduction in temperature of exhaust gases while they flow into the catalytic converter from the engine. In addition, a similar insulation is also applied to piping of a heat recovery mechanism for sending back exhaust gases to the induction side again for quickly warming up the engine.

In a general insulating construction for an exhaust pipe, a thermal insulation material is wound around the exhaust pipe. The thickness of such a thermal insulation material is increased to increase the insulation performance, leading to an increase in space for the exhaust pipe. In addition, there is also known a dual-pipe construction in which a layer of air is interposed between an exhaust pipe and an outer pipe. For example, in Patent Document 1, a metal wire material is wound around an exhaust pipe in a spiral manner to act as a spacer, and an outer pipe is fitted on the spacer. In the past, the applicant of the present application proposed in Patent Document 2 a dual-pipe construction in which ring-shaped spacers are adhered to an outer circumferential surface of an exhaust pipe at arbitrary intervals and a flexible outer pipe in which glass cloth is joined to an inner surface of a metallic foil is mounted on the spacers.

In the dual-pipe constructions described in Patent Documents 1 and 2, however, since the exhaust pipe and the metal wire material or the spacers have certain heat capacities, heat of exhaust gases is absorbed by the exhaust pipe and the metal wire material or the spacers, thereby inducing a reduction in temperature of exhaust gases. Because of this, when exhaust gases begin to flow into the exhaust pipe, the temperature of exhaust gases drops quickly. Thereafter, as the exhaust pipe and the metal wire material or the spacers are warming up, the temperature of exhaust gases gradually increases and becomes constant. However, the larger the heat capacities of the exhaust pipe and materials on the periphery thereof, the longer the time required for the temperature of exhaust gases to become constant, and the exhaust gas temperature which has become constant (the reachable temperature) takes a low value. Further, from the spatial point of view, adopting the dual-pipe construction increases the space required for the exhaust pipe by a space required for the outer pipe.

Patent Document 1: JP-A-2002-228055

Patent Document 2: JP-A-2004-285849

### SUMMARY OF THE INVENTION

The invention has been made in view of the background described above, and an object thereof is to provide an automotive exhaust pipe capable of shortening the time required for the exhaust pipe to be heated by exhaust gases compared to the conventional exhaust pipe and maintaining its reachable temperature high, without increase of the space required for the exhaust pipe.

Namely, the present invention relates to the following items (1) to (6).

(1) An automotive exhaust pipe comprising:

an exhaust pipe main body; and

a metallic cylindrical body being inserted inside the exhaust pipe main body, having openings at an open area ratio of 95% or smaller, and having a thickness of 3 mm or smaller.

(2) The automotive exhaust pipe according to (1), wherein a space between the exhaust pipe main body and the cylindrical body is 1 to 30 mm.

(3) The automotive exhaust pipe according to (1) or (2), wherein an interspace between the exhaust pipe main body and the cylindrical body is closed at either one or both end faces of the automotive exhaust pipe.

(4) The automotive exhaust pipe according to any one of (1) to (3), wherein a thermal insulation material is attached to an outer circumferential surface of the cylindrical body with a thickness that causes no contact with an inner wall of the exhaust pipe main body.

(5) The automotive exhaust pipe according to any one of (1) to (3), wherein a thermal insulation material is attached to an inner wall of the exhaust pipe main body with a thickness that causes no contact with the cylindrical body.

(6) The automotive exhaust pipe according to any one of (1) to (3), wherein a thermal insulation material is attached to an inner wall of the cylindrical body with a thickness that does not fill the cylindrical body.

In the automotive exhaust pipe of the invention, the cylindrical body inserted inside the exhaust pipe main body is made up of the sheet metal and its heat capacity is small. Because of this, the temperature of the cylindrical body is easily increased by the heat of exhaust gases which flow inside thereof, and a difference in temperature between the exhaust gases and the cylindrical body immediately becomes small, whereby the heat loss from the exhaust gases to the cylindrical body is reduced. Because of this, compared with a case where the exhaust pipe is made up of only the exhaust pipe main body, the time required to increase the temperature of the exhaust pipe is shortened considerably. This advantage is increased further, for example, by attaching a thermal insulation material to an inner wall of the exhaust pipe main body with a thickness that causes no contact with the cylindrical body. Moreover, since the cylindrical body and further the thermal insulation material are only inserted inside the exhaust pipe main body, the space required for the exhaust pipe does not increase.

### BRIEF DESCRIPTION OF THE DRAWINGS

FIG. 1 is a sectional view showing an automotive exhaust pipe of the invention.

FIGS. 2A to 2G are plan views showing examples of opening configurations for a cylindrical body.

FIG. 3 is a sectional view showing another example of an automotive exhaust pipe of the invention.

FIG. 4 is a sectional view showing another example of an automotive exhaust pipe of the invention.

FIG. 5 is a sectional view showing another example of an automotive exhaust pipe of the invention.

FIG. 6 shows simulation results of Test 1.

FIG. 7 shows simulation results of Test 1.

FIG. 8 shows simulation results of Test 1.

FIG. 9 shows results of Test 2.

FIG. 10 shows results of Test 3 when a cylindrical body having a sheet thickness of 0.1 mm is used.

FIG. 11 shows results of Test 3 when a cylindrical body having a sheet thickness of 0.4 mm is used.

FIG. 12 shows results of Test 3 when a cylindrical body having a sheet thickness of 0.8 mm is used.

FIG. 13 shows results of Test 3 when a cylindrical body having a sheet thickness of 1.0 mm is used.

FIG. 14 shows results of Test 3 when a cylindrical body having a sheet thickness of 1.5 mm is used.

FIG. 15 shows results of Test 3 when a cylindrical body having a sheet thickness of 2.0 mm is used.

FIG. 16 shows results of Test 3 when a cylindrical body having sheet thickness of 3.0 mm is used.

FIG. 17 shows results of Test 3 when a cylindrical body having a sheet thickness of 3.5 mm is used.

FIG. 18 shows results of Test 3 when a cylindrical body having a sheet thickness of 5.0 mm is used.

FIG. 19 shows results of Test 3 when a cylindrical body having sheet thickness of 10.0 mm is used.

FIG. 20 shows results of Test 4.

### DETAILED DESCRIPTION OF THE INVENTION

Hereinafter, an automotive exhaust pipe of the invention will be described in detail by reference to the drawings.

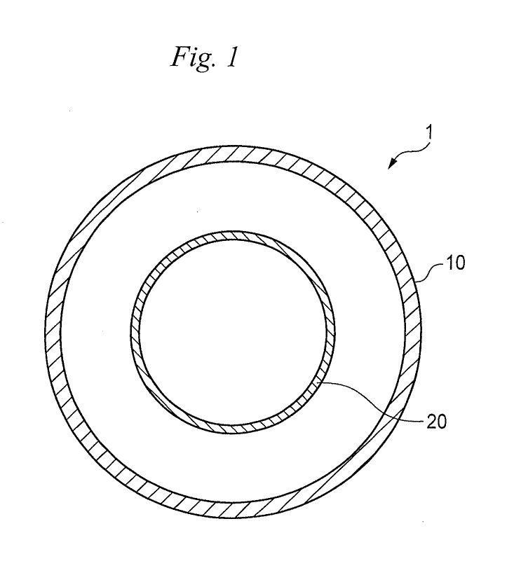

FIG. 1 is a sectional view showing an automotive exhaust pipe 1 of the invention. As is shown, a cylindrical body 20, which is made of sheet metal (1 to 3 mm in thickness), is installed inside an exhaust pipe main body 10, which originally constitutes an exhaust pipe, as keeping a predetermined distance from the exhaust pipe main body 10. Because the cylindrical body 20 is installed inside the exhaust pipe main body 10, the space to cover the exhaust pipe main body 10 with thermal insulation materials or different outer pipes is not necessary.

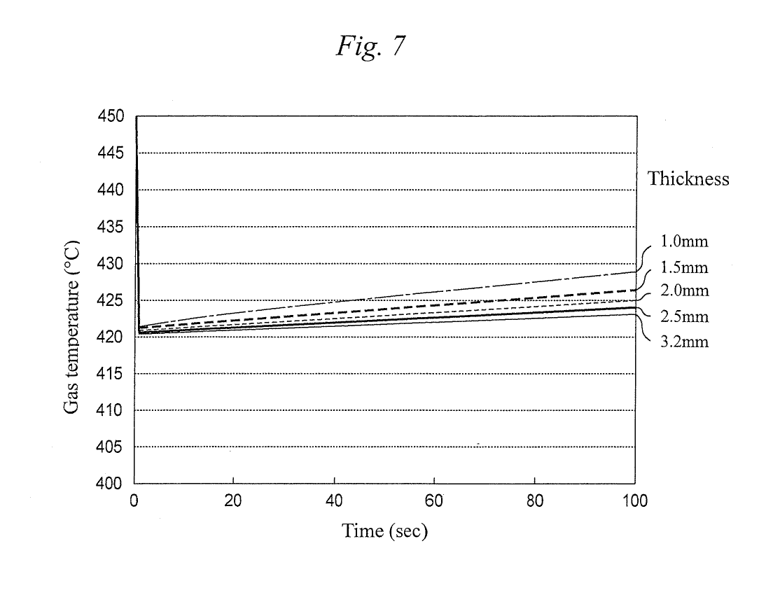

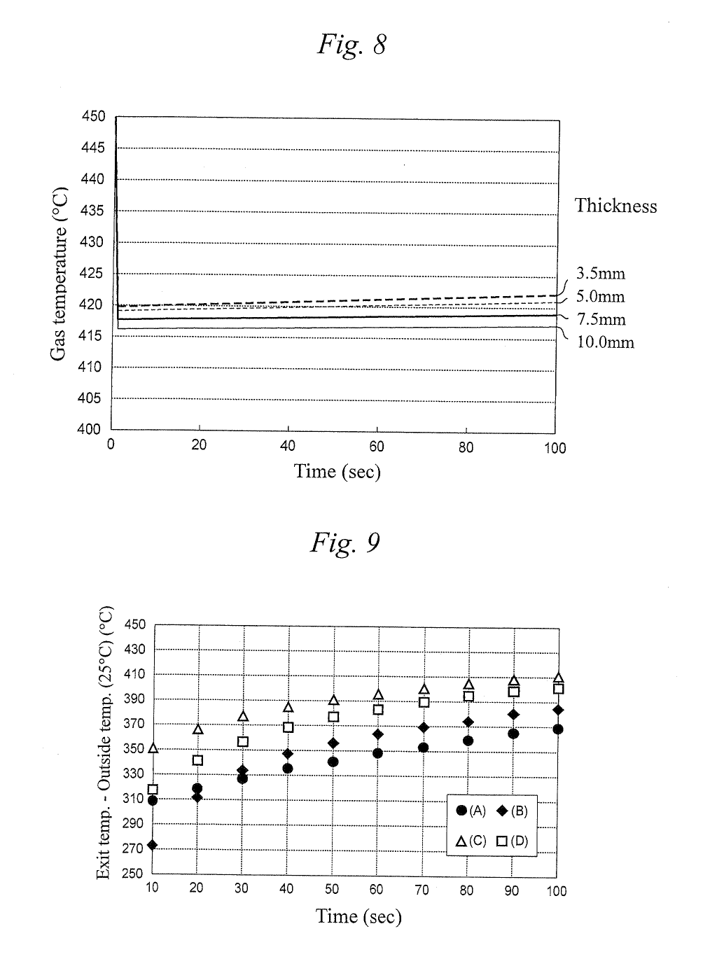

The cylindrical body 20 is preferably made of aluminum, iron, titanium or stainless steel since their heat capacities are small and they are little deteriorated by exhaust gases and are inexpensive in cost. In addition, the thickness of sheet metal used is preferably thin or small in order to reduce the heat capacity of the cylindrical body 20. Therefore, the thickness thereof is 3 mm or smaller. However, since the strength is decreased when the thickness is too small, the thickness is preferably 0.1 mm or larger. As shown in FIGS. 6 to 8, in the case where the thickness thereof exceeds 3 mm, the gas temperatures hardly increase, namely, the thermal insulations do not take effect very much. When the thickness thereof is in the range of 3 mm or smaller to larger than 2 mm, the temperature gently increases with time. Namely, the thermal insulation effect begins to appear. When the thickness is in the range of 2 mm or smaller to 1 mm, the temperature increase is accelerated, and the insulation effect appears early. When the thickness thereof is in the range of 1 mm or smaller to larger than 0.8 mm, the time to increase the temperature of the cylindrical body 20 is shortened. Then, the temperature increase rate is increased sequentially in the order of a thickness range of 0.8 mm or smaller to larger than 0.4 mm, a thickness range of 0.4 mm or smaller to larger than 0.2 mm and a thickness range of 0.2 mm or smaller to 0.1 mm.

An exhaust pipe is often bent any desired curvature to install itself around an engine. Therefore, because the automotive exhaust pipe 1 has the double structure that the cylindrical body 20 is inserted into the exhaust pipe main body 10, both pipes in the automotive exhaust pipe 1 could contact with each other at bending it. Furthermore, the thickness of the cylindrical body 20 is so thin that it would be broken by bending.

A space between the exhaust pipe main body 10 and the cylindrical body 20 is preferably in the range of 1 to 30 mm, and an appropriate space is selected in accordance with a diameter of the exhaust pipe main body 10. Exhaust gases flow through inside the cylindrical body 20. An air layer is formed in an interspace between the exhaust pipe main body 10 and the cylindrical body 20 so as to insulate the cylindrical body 20 against the heat loss or heat transfer from the cylindrical body 20. However, in the case where the space exceeds 30 mm, convection is generated in the air layer, whereby the thermal insulation performance is decreased. On the other hand, when the air layer is smaller than 1 mm, it is so thin that the thermal insulation performance would decrease similarly.

In addition, the heat capacity of the cylindrical body 20 can be decreased further by forming openings on the surface of the cylindrical body 20. In this case, the overall density of the cylindrical body decreases as the open area ratio of the cylindrical body 20, that is, a ratio of the total area of opening to the area of the cylindrical body 20 increases, and hence, the heat capacity decreases. However, as the open area ratio increases too much, heat exchange occurs between air in the air layer and high-temperature exhaust gases, and the air layer and the opening spaces formed in the cylindrical body cannot be discriminated from each other. Therefore, when thermal insulation is considered seriously, the excessive increase of the open area ratio is rather becomes disadvantageous. In addition, as the open area ratio increases, the overall strength of the cylindrical body decreases. Because of these, the open area ratio is made to be 95% or smaller. Preferably, the open area ratio is 55% or smaller.

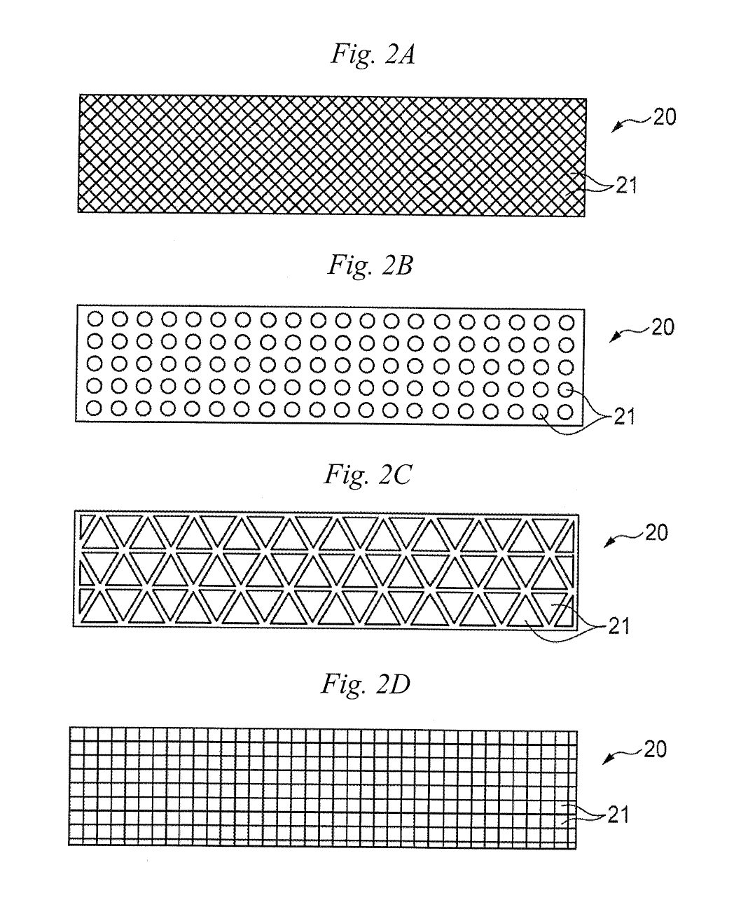

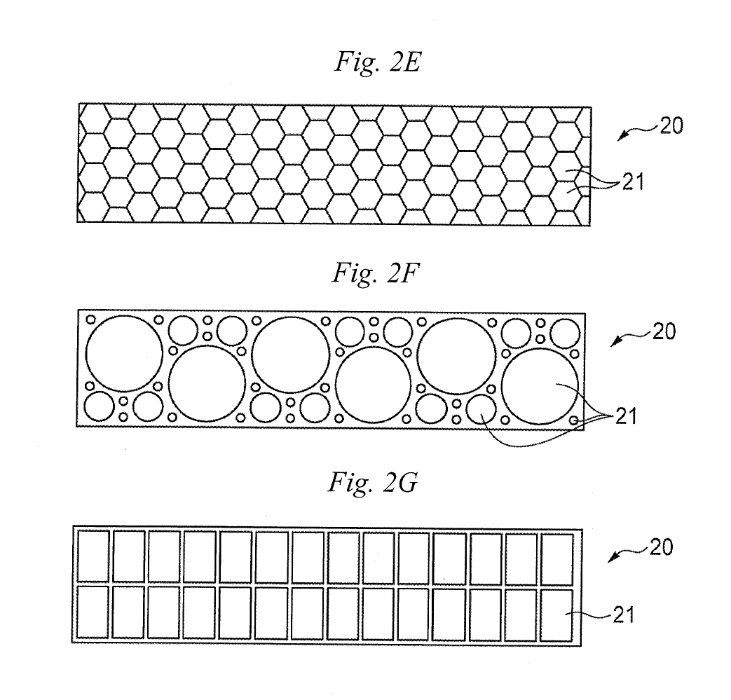

There is no limitation on the configuration of openings formed in the cylindrical body as long as the above-mentioned open area ratio is satisfied. For example, openings 21 of a variety of configurations shown in FIGS. 2A to 2G can be formed in the cylindrical body. In addition, the openings 21 may be formed shapeless. However, in the case where individual openings 21 are enlarged in size, exhaust gases tend to pass through the openings 21 to reach the exhaust main body 10. Therefore, many small openings 21 are preferably formed.

In fabricating the cylindrical body 20 in which the openings 21 are formed, sheet metal (1 to 3 mm in thickness) in which openings 21 formed may be bent into a cylindrical shape with longitudinal ends butted up against each other to be welded together. As the sheet metal (1 to 3 mm in thickness) in which the openings 21 are opened, commercially available products such as meshed metal in which metallic wires are braided into a net-like manner, expanded metal and punching metal may be used.

When fabricating the automotive exhaust pipe 1, first, the cylindrical body 20 is expanded in diameter locally at an appropriate location or ring-shaped spacers are fixed to an outer circumferential surface of the cylindrical body 20 at appropriate intervals. Then, the cylindrical body 20 may be inserted into the exhaust pipe main body 10. In addition, interspaces between the exhaust pipe main body 10 and the cylindrical body 20 may be left open at both end portions of the automotive exhaust pipe. However, the interspaces may be closed at either one or both end faces of the automotive exhaust pipe by spacers, whereby heat transfer from the opened portions of the interspaces due to radiation and convection can be prevented.

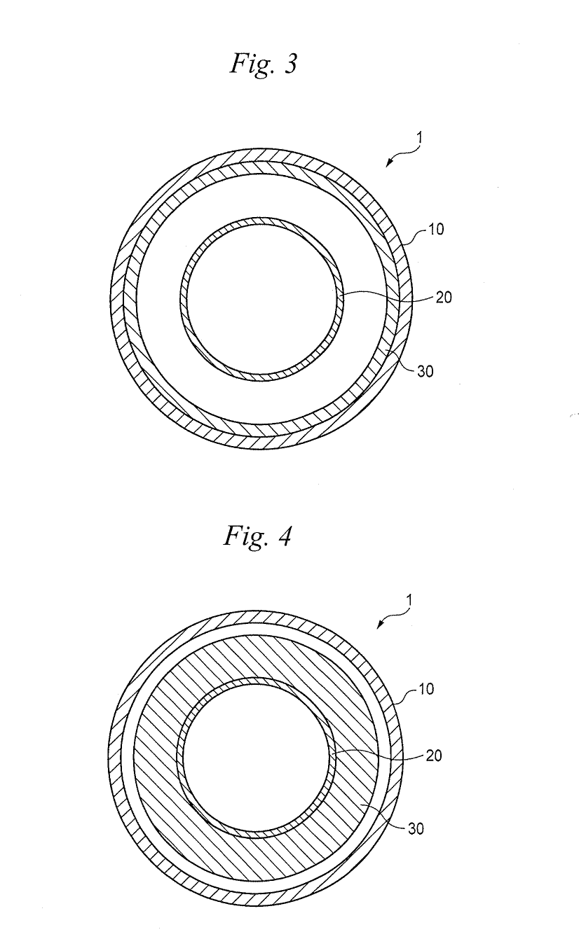

In addition, as shown in FIG. 3, a thermal insulation material 30 can be attached to an inner wall of the exhaust pipe main body 10 with a thickness that causes no contact with the cylindrical body 20. By attaching the thermal insulation material 30 in that way, an amount of heat dissipated to the outside through the exhaust pipe main body 10 can be reduced, thereby enabling the exhaust pipe 1 to have a better thermal insulation performance. However, in the case where the interspace between the exhaust pipe main body 10 and the cylindrical body 20 is eliminated, the thermal insulation effect by the air layer formed between the exhaust pipe main body 10 and the cylindrical body 20 could not appear clearly. Therefore, the thickness of the thermal insulation material 30 is preferably 5 to 95% of the space between the exhaust pipe main body 10 and the cylindrical body 20.

The thermal insulation material 30 is preferably made of an inorganic material, and for example, an inorganic material in which inorganic fibers such as glass fibers and silica fibers, alumina fibers, rock wool or the like are integrated by an inorganic binder or a small amount of organic binder may be used. In addition, calcium silicate, microporous or nanosize particulate materials may be contained in such an inorganic material. Further, the thermal insulation material 30 preferably has a density of 10 to 300 kg/m³ from the viewpoint of thermal insulation performance. Incidentally, in order to join the thermal insulation material 30 to the inner wall of the exhaust pipe main body 10, an appropriate adhesive can be used. In the case where the thermal insulation material 30 is a cylindrical shape, the thermal insulation material 30 may be inserted into the exhaust pipe main body 10 without using the adhesive. In the latter case, the occurrence of outgassing originated from the use of adhesive is preferably eliminated.

Further, as shown in FIG. 4, a thermal insulation material 30 may be attached to an outer circumferential surface of the cylindrical body 20 with a thickness that causes no contact with the inner wall of the exhaust pipe main body 10. Concretely, the thermal insulation material 30 preferably has a thickness equal to 5 to 95% of the space between the exhaust pipe main body 10 and the cylindrical body 20.

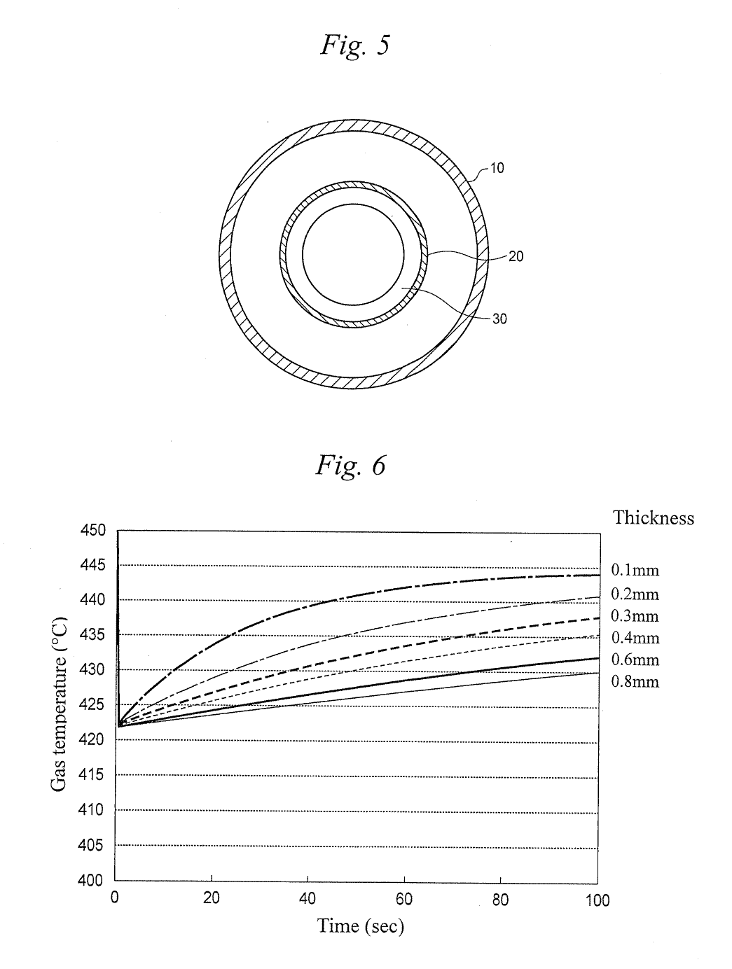

Furthermore, as shown in FIG. 5, a thermal insulation material 30, which does not fill up the cylindrical body 20, may be attached to an inner wall of the cylindrical body 20. Concretely, the thermal insulation material 30 preferably has a thickness equal to 5 to 95% of an inside diameter of the cylindrical body 20.

### EXAMPLES

### (Test 1)

A change with time in temperature of exhaust gases flowing through inside the cylindrical body was simulated under the following conditions.

Cylindrical Bodies: stainless steel pipes with thicknesses of 0.1 mm, 0.2 mm, 0.3 mm, 0.4 mm, 0.6 mm, 0.8 mm, 1.0 mm, 1.5 mm, 2.0 mm, 2.5 mm, 3.2 mm, 3.5 mm, 5.0 mm, 7.5 mm, 10. 0 mm; No opening opened; Outside diameter 38.1 mm

Outside Temperature: 25° C.

Gas Temperature: 450° C.

Results of simulations are shown in FIGS. 6 to 8. It is seen from graphs that the temperature increasing rate increases as the thickness of the cylindrical body decreases, and this indicates that small heat capacities are desirable. Good results could be obtained in particular with thicknesses of 3 mm or smaller.

### (Test 2)

The following sample exhaust pipes were prepared: (A) An exhaust pipe constructed by only a cylindrical body (outside diameter of 38.1 mm, a stainless steel pipe with a thickness of 1.2 mm, open area ratio of 0%), (B) An exhaust pipe with a cylindrical body (a punching metal pipe of a stainless steel with a thickness of 0.4 mm, open area ratio of 32.6%, outside diameter of 38.1 mm) attached as shown in FIG. 1, (C) An exhaust pipe with a cylindrical body similar to that of (B) attached and further a thermal insulation material (with a thickness of 3 mm and made of glass fibers with a density of 200 kg/m³) attached to an outer circumferential surface of the cylindrical body, as shown in FIG. 4, and (D) An exhaust pipe with a cylindrical body similar to that of (B) attached and further a thermal insulation material (with a thickness of 3 mm and made of glass fibers with a density of 200 kg/m³) attached to the inner wall of the exhaust pipe main body, as shown in FIG. 3.

Then, air heated to 500° C. was caused to flow through the respective cylindrical bodies, and the temperature differences between at the exit of the pipe and outside were measured to obtain a difference from the outside temperature (constant at 25° C.). The flowing time was 100 seconds. The changes of the air temperatures with time during the flowing time are shown in FIG. 9. It is seen from the figure that the temperature increasing rates of the exhaust pipes (B) to (D) are higher than that of (A) which is only the exhaust pipe main body. The temperature increasing rates of the exhaust pipes (C) and (D) increase especially, because the thermal insulations were attached them.

### (Test 3)

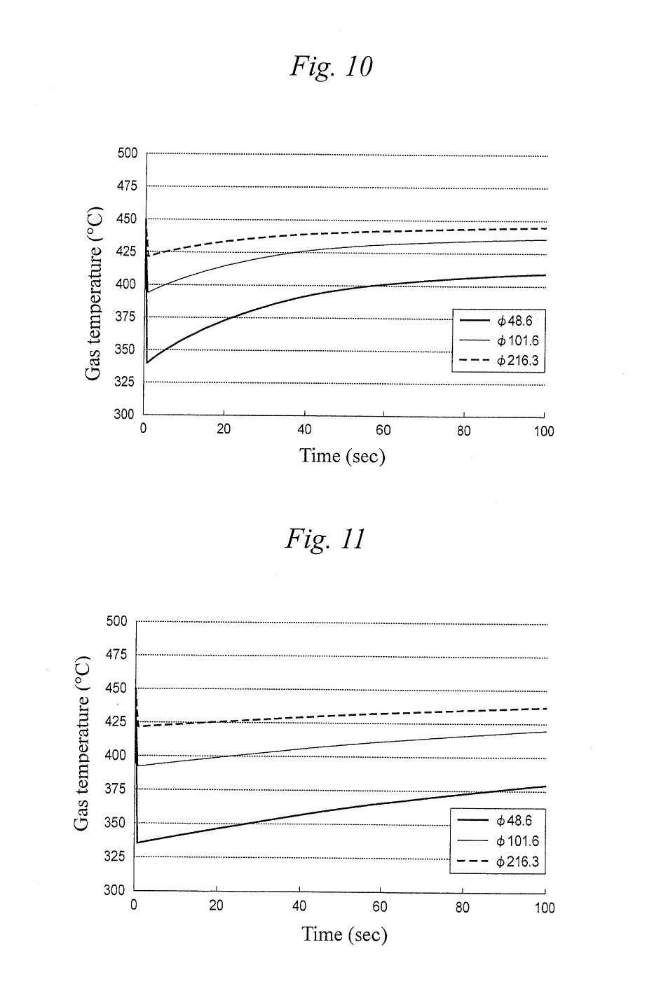

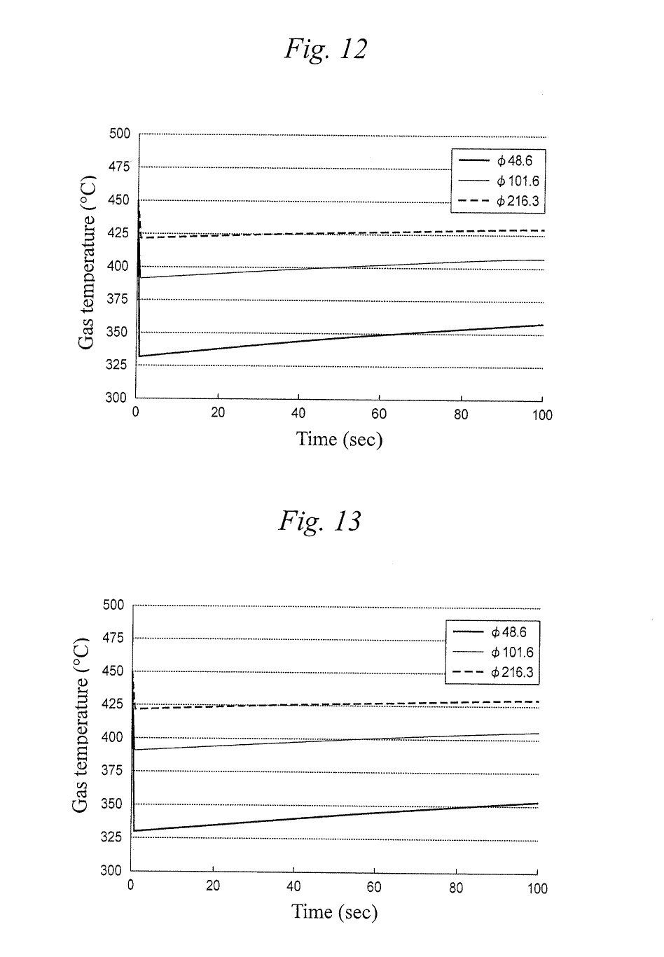

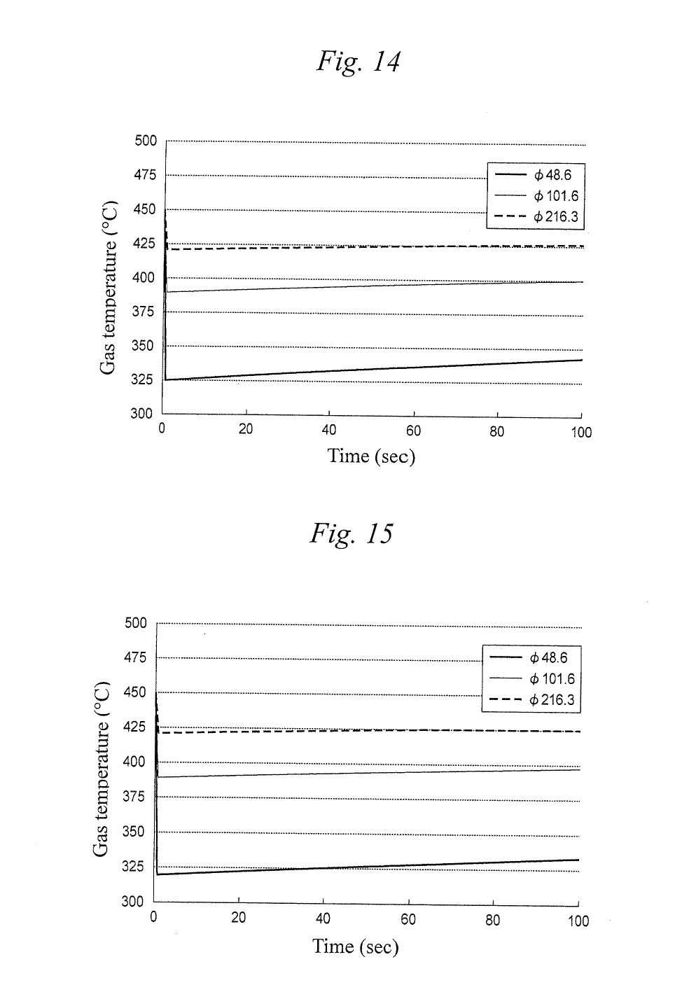

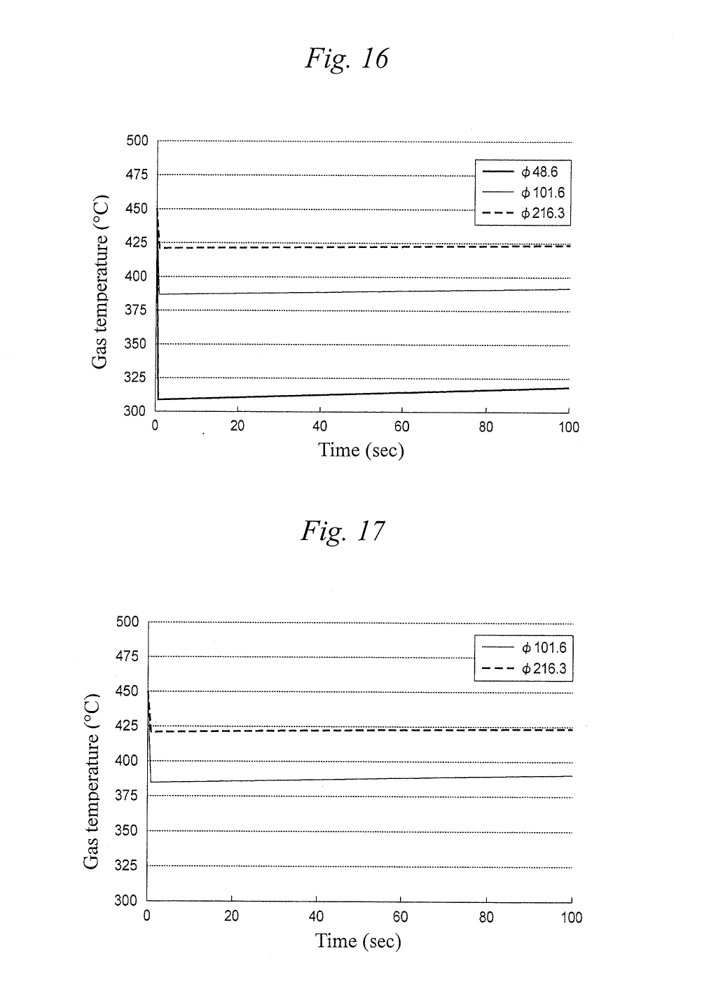

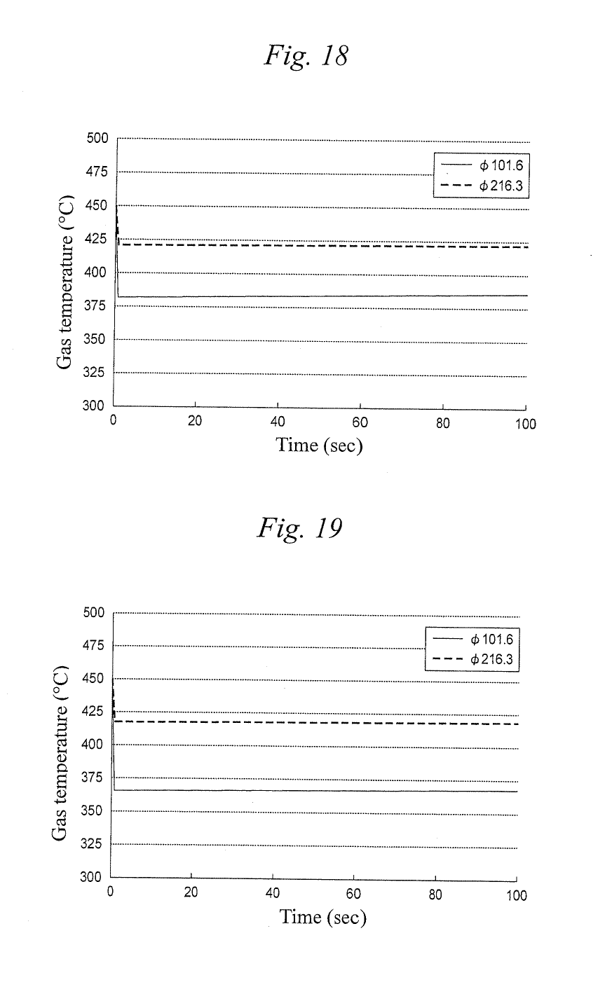

The changes of the gas temperature to the different diameters of the cylindrical bodies with time were calculated, and the results are shown in FIGS. 10 to 19. Namely, there were prepared three different types of exhaust pipe main bodies whose diameters were 48.6 mm, 101.6 mm, and 216.3 mm. Then, cylindrical bodies whose thicknesses were 0.1 mm, 0,4 mm, 0.8 mm, 1.0 mm, 1.5 mm, 2.0 mm, 3.0 mm, 3.5 mm, 5.0 mm, 10.0 mm were prepared for insertion into the exhaust pipe main bodies. Then, when the gas heated to 450° C. was caused to flow through the cylindrical bodies, the temperatures at the exit of the pipes were calculated. As shown in FIGS. 10 to 19, it was confirmed that in the case where the thickness exceeds 3 mm, no change with time in temperature occurred in the respective pipings and hence no thermal insulation effect appeared.

### (Test 4)

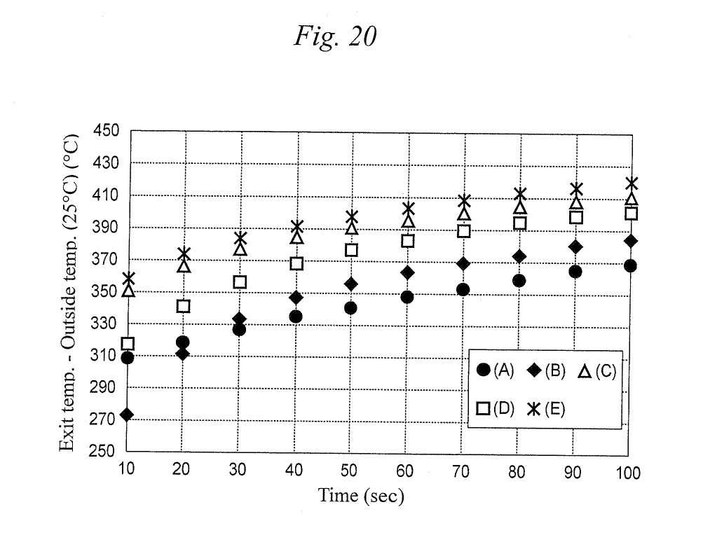

As shown in FIG. 5, a thermal insulation material (3 mm in thickness and made of glass fibers whose density of 200 kg/m³) was attached to an inner wall of a cylindrical body (a punching metal pipe of a stainless steel whose sheet thickness was 0.4 mm with a open area ratio of 32.6% and an outside diameter of 38.1 mm) and was installed concentrically with an exhaust pipe main body (with an inside diameter of 46.2 mm and made of a stainless steel pipe whose sheet thickness was 1.2 mm). Then, the temperatures at the exit of the exhaust pipe were measured in a similar way to that of Test 2 to obtain temperature differences from the outside temperature (25° C.). The results of the measurement are shown in FIG. 20. A plot (E) in the figure denotes results obtained on the exhaust pipe in which the thermal insulation material was attached to the inner wall of the cylindrical body. In addition, for the sake of comparison, plots (A) to (D) obtained in Test 2 are also shown in the figure.

As shown in FIG. 20, the temperature increasing rate of the exhaust pipe (E), in which the thermal insulation material was attached to the inner wall of the cylindrical body, is found to be higher than those of (C) and (D).

While the invention has been described in detail and with reference to specific embodiments thereof, it will be apparent to one skilled in the art that various changes and modifications can be made therein without departing from the spirit and scope thereof.

This application is based on Japanese Patent Applications No. 2009-192073 filed on Aug. 21, 2009 and No. 2010-081803 filed on Mar. 31, 2010, and the contents are incorporated herein by reference.

Also, all the references cited herein are incorporated as a whole.

According to the automotive exhaust pipe of the present invention, it is possible to shorten the time required for the exhaust pipe to be heated by exhaust gases compared to the conventional exhaust pipe and to maintain its reachable temperature high, without increase of the space required for the exhaust pipe.

### DESCRIPTION OF REFERENCE NUMERALS AND SIGNS

1 Automotive exhaust pipe
10 Exhaust pipe main body
20 Cylindrical body
21 Opening
30 Thermal insulation material

What is claimed is:

1. An automotive exhaust pipe comprising:
an exhaust pipe main body; and
a metallic cylindrical body being inserted inside the exhaust pipe main body, having openings at an open area ratio of 95% or smaller, and having a thickness of 3 mm or smaller.

2. The automotive exhaust pipe according to claim 1, wherein a space between the exhaust pipe main body and the cylindrical body is 1 to 30 mm.

3. The automotive exhaust pipe according to claim 1, wherein an interspace between the exhaust pipe main body and the cylindrical body is closed at either one or both end faces of the automotive exhaust pipe.

4. The automotive exhaust pipe according to claim 1, wherein a thermal insulation material is attached to an outer circumferential surface of the cylindrical body with a thickness that causes no contact with an inner wall of the exhaust pipe main body.

5. The automotive exhaust pipe according to claim 1, wherein a thermal insulation material is attached to an inner wall of the exhaust pipe main body with a thickness that causes no contact with the cylindrical body.

6. The automotive exhaust pipe according to claim 1, wherein a thermal insulation material is attached to an inner wall of the cylindrical body with a thickness that does not fill the cylindrical body.
